(19) United States
(12) Patent Application Publication
(10) Pub. No.: US 2023/0243381 A1
(43) Pub. Date: Aug. 3, 2023

(54) Adapted Screw Head and Screwdriver Device

(71) Applicant: Donald Barbour, Petawawa (CA)

(72) Inventor: Donald Barbour, Petawawa (CA)

(21) Appl. No.: 17/688,074

(22) Filed: Mar. 7, 2022

Related U.S. Application Data
(60) Provisional application No. 63/306,294, filed on Feb. 3, 2022.

(51) Int. Cl. F16B 23/00; B25B 15/02; B25B 15/00; B25G 1/10; B25B 23/12

(52) U.S. Cl. CPC F16B 23/0015; B25B 15/02; B25B 15/007; B25G 1/102; B25B 23/12

(57) ABSTRACT

The present invention relates to a novel adapted screw head and screw driver device which prevents stripping. The device comprises a multipurpose flat tip screw and an associated screwdriver. The screw head comprises a tapered opening, which is sized to accommodate the screwdriver in a snug fit. This prevents the screwdriver from slipping out of the screw head.

### CROSS-REFERENCE TO RELATED APPLICATION

The present application claims priority to, and the benefit of, U.S. Provisional Application No. 63/306,294, which was filed on Feb. 3, 2022 and is incorporated herein by reference in its entirety.

### FIELD OF THE INVENTION

The present invention relates generally to the field of screws and screwdriver devices. More specifically, the present invention relates to an improved screw and screwdriver device that provides users with a flat tip screwdriver and screws used to fasten different items. Specifically, the device comprises a screw and a screwdriver of specific dimensions to fit snugly and prevent slipping out under pressure. Accordingly, the present disclosure makes specific reference thereto. Nonetheless, it is to be appreciated that aspects of the present invention are also equally applicable to other like applications, devices and methods of manufacture.

### BACKGROUND

By way of background, screws and bolts of various designs are known and are commonly used as fasteners for assembly of useful articles. Characteristically, screws have a threaded shank portion, a tip design depending on the application, and a head having one or more slots. Driver bits of various designs are configured to fit the drive slot or slots on the screw head and engage the screw by transmitting a rotary force or torque through the driver bit to the screw head, generally through the screw head slot sidewalls.

Screwdriver tips generally have a relatively short blade tip length at the portion that engages the screw head. Screws are inserted or removed from a work piece by the application of a twisting force or torque to the head of the screw. Generally, for a screw, the axis of revolution is through the center of the head, and the driver to head contact distance is the smaller of half the slot length or half the drive tip blade length. As is well known, the force applied by the screwdriver blade tip to the slot wall of the screw head increases as the driver head to screw head contact distance decreases.

As screw heads are of rather small diameter, a given value of torque applied to drive or remove a screw from a work piece results necessarily in significant forces applied by the driver tip against the walls of the slot of the screw. This large sidewall force can result in the distortion of the slot in the screw head, requiring increasing amounts of downward force to be applied on the screwdriver and tip to keep the driver tip within the screw slot and prevent it from riding out of the slot in the now-deformed and damaged screw slot walls. A failure of the user to provide sufficient downward force results in the driver tip riding out of the slot and further damaging the screw sidewall and thereby requiring even more downward force to be applied. This series of events progressively damages the screw slot to the point where sufficient torque can no longer be transmitted to the screw by the driver tip as the driver tip now easily rides over and out of the now-deformed slot sidewalls. This undesirable tendency of the screw head sidewalls to deform and damage is referred to herein as ‘stripping’ and is an undesirable limitation of commonly known screw and screwdriver tip designs.

Therefore, a novel screwdriver tip and screw head device is needed that can prevent damage to the screw head slot. Specifically, a screw head design is needed that can capture the driver tip in the head and thereby prevent the screw head from stripping. Further, a useful device is needed that reduces the amount of downward force needing to be applied through the screwdriver to the screw head, to keep the driver tip from riding out of the screw slot.

Therefore, there exists a long-felt need in the art for an adapted screw head and screwdriver device that prevents stripping. There is also a long-felt need in the art for an adapted screw head and screwdriver device that are dimensioned to fit snugly and prevent slipping out under pressure. Further, there is a long-felt need in the art for an adapted screw head and screwdriver device that simplifies and reduces the number of screwdrivers and screw types needed to complete a task. Moreover, there is a long-felt need in the art for a device that saves a user time and money. Further, there is a long-felt need in the art for an adapted screw head and screwdriver device that can be used for providing a screw head with a top that accommodates the combined screwdriver in a snug and secure manner. Finally, there is a long-felt need in the art for an adapted screw head and screwdriver device that comprises different sizes and configurations of screws to securely fasten any type of item.

The subject matter disclosed and claimed herein, in one embodiment thereof, comprises an adapted screw head and screwdriver device. The device is designed to prevent stripping. Specifically, the adapted screw head and screwdriver device are dimensioned to fit snugly and prevent slippage under pressure. The device comprises a multipurpose flat tip screw and an associated screwdriver. The screw head comprises a specific dimension opening which is sized to accommodate the screwdriver in a snug fit. This prevents the screwdriver from slipping out of the screw head.

In this manner, the adapted screw head and screwdriver device of the present invention accomplishes all of the forgoing objectives and provides users with a device that prevents stripping. The device is dimensioned to fit snugly and prevent slippage under pressure. The device simplifies and reduces the number of screwdrivers and screw types needed to complete a task.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an adapted screw head and screwdriver device. The device is designed to prevent stripping. Specifically, the adapted screw head and screwdriver device are dimensioned to fit snugly and prevent slippage under pressure. The device comprises a multipurpose flat tip screw and an associated screwdriver. The screw head comprises a specific dimension opening which is sized to accommodate the screwdriver in a snug fit. This prevents the screwdriver from slipping out of the screw head. Accordingly, utilizing the herein embodiments of a screw head and a screwdriver tip in combination reduces the chance of stripping the screw head when inserting or removing a screw from a work piece.

In one embodiment, a screw head for a threaded screw shank comprises a tapered slot bisecting a top end portion of the head, wherein the screw head is secured at an opposing bottom end to the shank portion. The screw head comprises a slot tapered across the top portion of the head, such that the slot is narrowest at a center portion of the head and widens outwardly towards the circumferential side edges of the screw head. The screw head slot having substantially opposing inclined sidewall surfaces connected by a substantially flat bottom surface. The walls of the screw head slot are inclined to form a tapered wedge for capturing the screwdriver tip against the sidewalls and the flat bottom surface. In the same embodiment the screwdriver tip is sized and configured for being received and engaged into the screw head slot. The screwdriver tip having a screw slot insertion end, a driven portion, and a middle portion between the insertion end and the driven portion. The screwdriver tip comprises a tip bottom face at the insertion end of the tip.

In a further embodiment, the screw head sidewalls taper continuously from the bottom surface of the screw head slot up the head to the top end portion of the head, at an angle between 45 and 89 degrees relative to the slot bottom surface. Further, the screwdriver tip is continuously tapered, sized and formed to be received into the screw head slot and retentively engaged by the screw head slot.

In another embodiment, the tapered slot of the screw head is elongated, if the screw head allows, into the screw head itself. The elongated tapered slot then forms an extra deep screw head insertion, which increases surface area. Thus, the elongated tapered slot provides additional surface area to resist torsional stripping.

In yet another embodiment, a serrated screw thread is provided. Specifically, the thread of the screw shank comprises small serrations. The small serrations on the thread require less torque from a user to insert the screw and make screw removal easier.

In another embodiment, the screwdriver tip and shaft can be magnetic, such that a ferrous screw would adhere to the screwdriver tip. This magnetic attraction would retain the screw, preventing it from falling off the screwdriver tip. Additional methods of securing the screw can also be utilized, such as a snap ring, a ball of elastomeric or epoxy material positioned in the screwdriver tip, etc., to help retain the screws.

In yet another embodiment, the screw is manufactured from stainless steel, brass, bronze, zinc-coated steel, galvanized steel, or any other suitable type of ferrous material as is known in the art. Further, the screwdriver is typically manufactured from tool steel, but can be manufactured from the same material as the screw, such as stainless steel, brass, bronze, zinc-coated steel, galvanized steel, etc.

In another embodiment, the handle of the screwdriver comprises a molded plastic, slip-resistant surface, which allows a user to easily grip the screwdriver. The surface can also comprise an ergonomic grip or other gripping means. The handle can also be a ratcheting or double-ratcheting handle. Further, the handle can comprise a spin cap. The spin cap is positioned at an end of the handle and is an independent spinning head. The spin cap allows a user to rotate the screwhead, while having the palm of their hand on the spin cap, creating positive pressure on the screw.

In yet another embodiment, a method of inserting or removing a screw with a screwdriver without stripping is described. The method includes the steps of providing a multipurpose flat tip screw and an associated screwdriver, wherein the screw head comprises a specific dimensioned opening, which is sized to accommodate the screwdriver in a snug fit. The method continues with inserting the screwdriver tip into the opening of the screw head. The snug fit of the screwdriver prevents the screwdriver from slipping out of the screw head. Finally, the method ends with applying torque to the screwdriver to drive the screw securely into the item in use. Accordingly, utilizing the herein embodiments of a screw head and a screwdriver tip in combination reduces the chance of stripping the screw head when inserting or removing a screw from a work item.

In yet another embodiment of the present invention, an adapted screw head and screwdriver device is disclosed to prevent stripping. Specifically, the adapted screw head and screwdriver device are dimensioned to fit snugly and prevent slippage under pressure. The device comprises a multipurpose flat tip screw and an associated screwdriver. The screw head comprises a tapered opening, which is sized to accommodate the screwdriver in a snug fit. This prevents the screwdriver from slipping out of the screw head.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the adapted screw head and screwdriver device of the present invention in accordance with the disclosed architecture;

FIG. 2 illustrates a perspective view of one embodiment of the screwdriver tip being inserted into the screw head of the present invention in accordance with the disclosed architecture;

FIG. 3 illustrates a perspective view showing a plurality of screws of the present invention in accordance with the disclosed architecture; and

FIG. 4 illustrates a flowchart showing the method of inserting or removing a screw with a screwdriver without stripping in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an adapted screw head and screwdriver device that prevents stripping. There is also a long-felt need in the art for an adapted screw head and screwdriver device that are dimensioned to fit snugly and prevent slipping out under pressure. Further, there is a long-felt need in the art for an adapted screw head and screwdriver device that simplifies and reduces the number of screwdrivers and screw types needed to complete a task. Moreover, there is a long-felt need in the art for a device that saves a user time and money. Further, there is a long-felt need in the art for an adapted screw head and screwdriver device that can be used for providing a screw head with a top that accommodates the combined screwdriver in a snug and secure manner. Finally, there is a long-felt need in the art for an adapted screw head and screwdriver device that comprises different sizes and configurations of screws to securely fasten any type of item.

The present invention, in one exemplary embodiment, is an adapted screw head and screwdriver device. The device comprises a multipurpose flat tip screw and an associated screwdriver. The screw head comprises a tapered opening which is sized to accommodate the screwdriver in a snug fit. This prevents the screwdriver from slipping out of the screw head. The present invention also includes a novel method of inserting or removing a screw with a screwdriver without stripping. The method includes the steps of providing a multipurpose flat tip screw and an associated screwdriver. The method continues with inserting the screwdriver tip into the opening of the screw head. The snug fit of the screwdriver prevents the screwdriver from slipping out of the screw head. Finally, the method ends with applying torque to the screwdriver to drive the screw securely into the item in use.

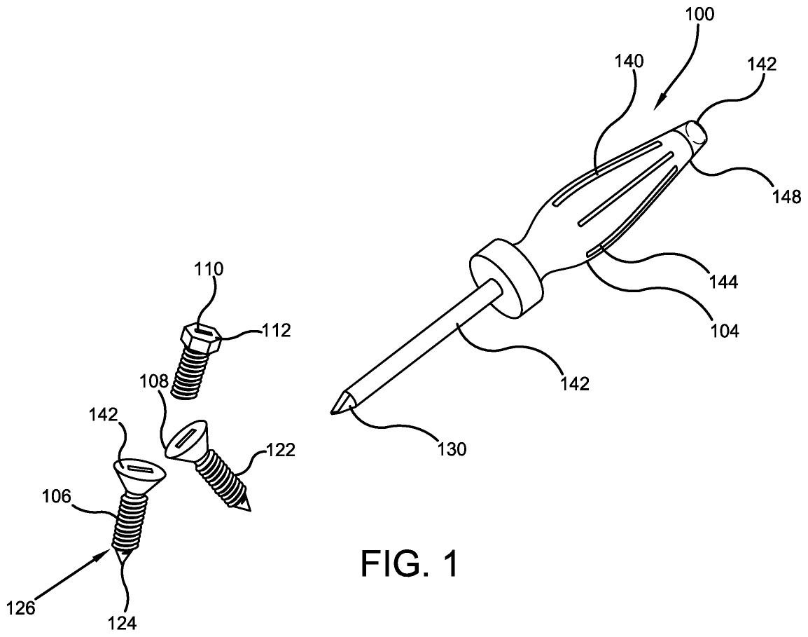

Referring initially to the drawings, FIG. 1 illustrates a perspective view of one embodiment of the adapted screw head and screwdriver device 100 of the present invention. In the present embodiment, the adapted screw head and screwdriver device 100 is an improved screw and screwdriver that when used in combination prevents screws from stripping during removal and/or insertion. The device 100 is especially designed to allow a user in a private setting or commercial setting, etc., or any other suitable user as is known in the art, to easily remove and/or insert a screw without stripping. More specifically, the device 100 comprises a multipurpose flat tip screw 102 and an associated screwdriver 104, wherein the screw 102 comprises a tapered slot or opening 110 which is sized to accommodate the screwdriver 104 in a snug fit. This prevents the screwdriver 104 from slipping out of the screw 102.

The screw 102 comprises a shank 106 onto which a screw head 108 is formed or secured. The screw head 108 is provided with a tapered slot or opening 110 which bisects the top portion or top face 112 of the screw head 108, wherein the screw head 108 is secured at an opposing bottom end 126 to the shank 106. The tapered slot 110 is narrower at the top portion or top face 112 of the screw head 108 and widens at the base 114 of the tapered slot 110, such that the tapered slot 110 side surfaces or sidewalls 116 taper into the sides of the screw head 108. Specifically, the tapered slot 110 is tapered across the top portion 112 of the screw head 108, such that the tapered slot 110 is narrowest at a center portion 118 of the screw head 108 and widens outwardly towards a circumferential edge 120. The tapered slot 110 also comprises substantially opposing inclined sidewall surfaces or sidewalls 116 connected by a substantially flat bottom surface 128. The sidewalls 116 of the tapered slot 110 are inclined to form a tapered wedge for capturing the screwdriver tip 130 against the sidewalls 116 and the flat bottom surface 128.

The screwdriver comprises a handle 140, a shaft 142, and a tip 130. The screwdriver tip 130 is sized and configured for being received and engaged into the tapered slot 110. The tip 130 having a screw slot insertion end 132, a driven portion 134, and a middle portion 136 between the insertion end 132 and the driven portion 134. The insertion end 132 has a bottom face 138, which when in use mates against the base 114 of the tapered slot 110.

In another embodiment, the handle 140 of the screwdriver 104 comprises a molded plastic, slip-resistant surface, which allows a user to easily grip the screwdriver 104. The surface can also comprise an ergonomic grip 144 or other gripping means. The handle 140 can also be a ratcheting or double-ratcheting handle. Further, the handle 140 can comprise a spin cap 146. The spin cap 146 is positioned at an end 148 of the handle 140 and is an independent spinning head. The spin cap 146 allows a user to rotate the screw head 108, while having the palm of their hand on the spin cap 146, creating positive pressure on the screw 102.

The screw 102 is typically manufactured from stainless steel, brass, bronze, zinc-coated steel, galvanized steel, or any other suitable type of ferrous material as is known in the art. Further, the screwdriver 104 is typically manufactured from tool steel, but can be manufactured from the same material as the screw 102, such as stainless steel, brass, bronze, zinc-coated steel, galvanized steel, etc.

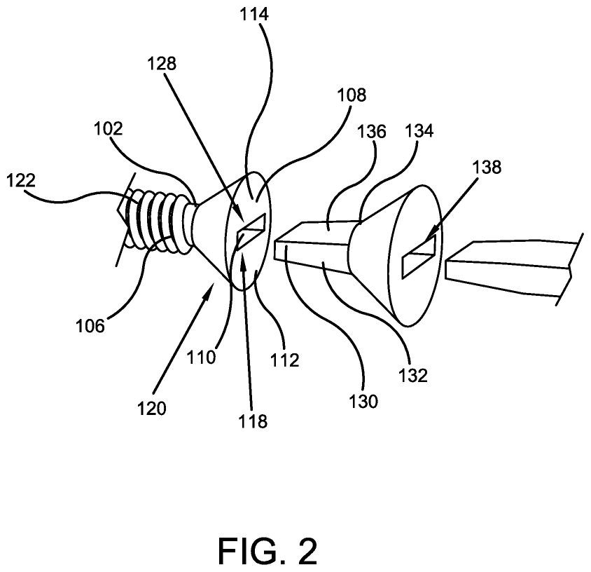

FIG. 2 illustrates a perspective view of the screwdriver tip 130 inserted into the screw head 108. The screw head sidewalls 116 taper continuously from the bottom surface or base 114 of the tapered slot 110 up the head 108 to the top end portion 112 of the head 108, at an angle between 45 and 89 degrees relative to the slot bottom surface or base 114. Further, the screwdriver tip 130 is continuously tapered, sized and formed to be received into the tapered slot 110 and retentively engaged by the tapered slot 110.

In another embodiment, the tapered slot 110 of the screw head 108 is elongated into the screw head 108 itself, if the screw head 108 allows for such a large slot. The elongated tapered slot 110 then forms an extra deep screw head insertion, which increases surface area. Thus, the elongated tapered slot provides additional surface area to resist torsional stripping.

In another embodiment, the screwdriver tip 130 and shaft 142 can be magnetic, such that a ferrous screw 102 would adhere to the screwdriver tip 130 and/or shaft 142. This magnetic attraction would retain the screw 102, preventing it from falling off the screwdriver tip 130 and/or shaft 142. Additional methods of securing the screw 102 can also be utilized, such as a snap ring, a ball of elastomeric or epoxy material positioned in the screwdriver tip 130, etc., to help retain the screws 102.

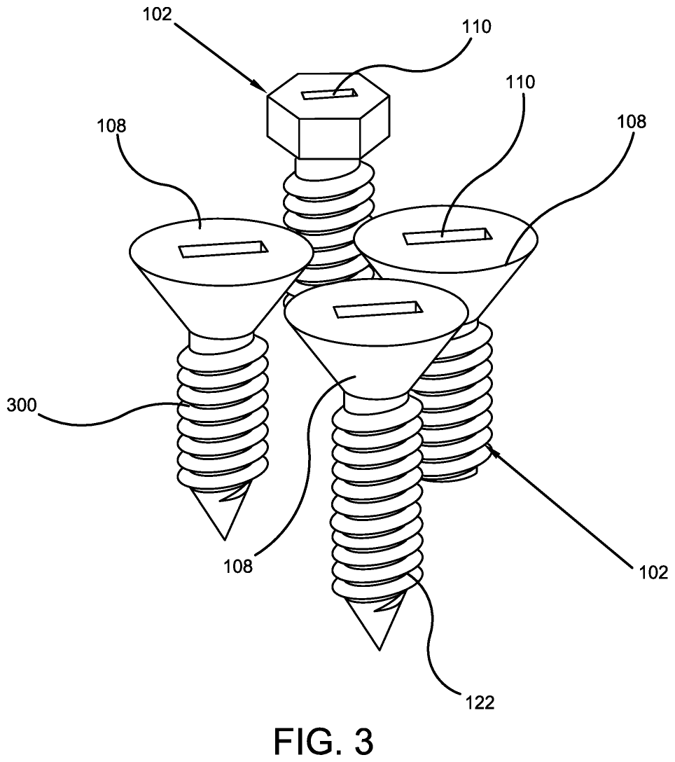

FIG. 3 illustrates a perspective view of a plurality of screws 102. The screw 102 comprises threads 122 around the shank 106. The threads 122 are typically positioned in a helical configuration around the shank 106, at a specific pitch. The pitch is the distance between threads, or the amount of rotations per length. The screw 102 also comprises a tip 124. The tip 124 can be flat, pointed, angled, etc., or any other suitable shape as is known in the art, depending on the wants and/or needs of a user.

In another embodiment, a serrated screw thread is provided. Specifically, the thread 122 of the screw shank 106 comprises small serrations 300. The small serrations 300 on the thread 122 require less torque from a user to insert the screw 102 and make screw removal easier.

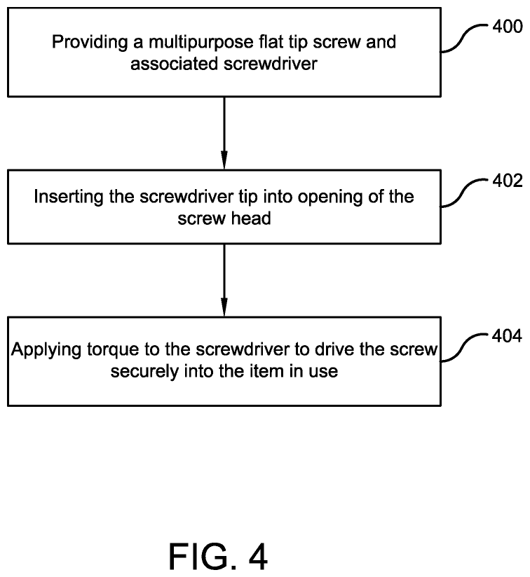

FIG. 4 illustrates a flowchart of the method of inserting or removing a screw with a screwdriver without stripping is described. The method includes the steps of, at 400, providing a multipurpose flat tip screw and an associated screwdriver, wherein the screw head comprises a tapered opening, which is sized to accommodate the screwdriver in a snug fit. The method continues at 402, with inserting the screwdriver tip into the opening of the screw head. The snug fit of the screwdriver prevents the screwdriver from slipping out of the screw head. Finally, the method ends at 404 with applying torque to the screwdriver to drive the screw securely into the item in use. Accordingly, utilizing the herein embodiments of a screw head and a screwdriver tip in combination reduces the chance of stripping the screw head when inserting or removing a screw from a work item.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “adapted screw head and screwdriver device” and “device” are interchangeable and refer to the adapted screw head and screwdriver device 100 of the present invention.

Notwithstanding the forgoing, the adapted screw head and screwdriver device 100 of the present invention can be of any suitable size and configuration as is known in the art without affecting the overall concept of the invention, provided that it accomplishes the above-stated objectives. One of ordinary skill in the art will appreciate that the adapted screw head and screwdriver device 100, as shown in FIGS. 1-4, is for illustrative purposes only, and that many other sizes and shapes of the adapted screw head and screwdriver device 100 are well within the scope of the present disclosure. Although the dimensions of the adapted screw head and screwdriver device 100 are important design parameters for user convenience, the adapted screw head and screwdriver device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An adapted screw head and screwdriver device that prevents stripping comprising:
a screw comprising a shank and a screw head secured to the shank; and
a screwdriver comprising a handle, a shaft, and a tip, wherein the screw head comprises a tapered slot sized and configured to accommodate the screwdriver tip, and further wherein, after insertion of the screwdriver tip into the tapered slot, the screw and the screwdriver fit snugly and prevent slipping out under pressure.

2. The adapted screw head and screwdriver device of claim 1, wherein the tapered slot bisects a top face of the screw head.

3. The adapted screw head and screwdriver device of claim 2, wherein the tapered slot is narrower at the top face of the screw head and widens at a base of the tapered slot.

4. The adapted screw head and screwdriver device of claim 3, wherein the tapered slot comprises sidewalls that taper into the screw head.

5. The adapted screw head and screwdriver device of claim 4, wherein the tapered slot is tapered across the top face of the screw head, such that the tapered slot is narrowest at a center portion of the screw head and widens outwardly towards a circumferential edge.

6. The adapted screw head and screwdriver device of claim 5, wherein the tapered slot comprises opposing inclined sidewall surfaces connected by a flat bottom surface.

7. The adapted screw head and screwdriver device of claim 6, wherein the screwdriver tip comprises a screw slot insertion end, a driven portion, and a middle portion between the insertion end and the driven portion.

8. The adapted screw head and screwdriver device of claim 7, wherein the screw slot insertion end comprises a bottom face that, when in use, mates against the flat bottom surface.

9. The adapted screw head and screwdriver device of claim 8, wherein the screwdriver handle comprises an ergonomic grip.

10. The adapted screw head and screwdriver device of claim 9, wherein the handle comprises a spin cap.

11. The adapted screw head and screwdriver device of claim 10, wherein each of the screwdriver tip and the shaft are magnetic.

12. The adapted screw head and screwdriver device of claim 11, wherein the screw is manufactured from a ferrous material.

13. The adapted screw head and screwdriver device of claim 12, wherein the screw comprises a plurality of threads around the shank.

14. The adapted screw head and screwdriver device of claim 13 wherein the plurality of threads are positioned in a helical configuration around the shank.

15. The adapted screw head and screwdriver device of claim 14, wherein the plurality of threads of the shank comprise small serrations.

16. An adapted screw head and screwdriver device that prevents stripping comprising:
a screw comprising a shank and a screw head secured to the shank; and
a screwdriver comprising a handle, a shaft, and a tip;
wherein the screw head comprises a tapered slot comprising opposing inclined sidewall surfaces connected by a flat bottom surface;
wherein the tapered slot bisects a top face of the screw head;
wherein the tapered slot is narrower at the top face of the screw head and widens at a base of the tapered slot; and
further wherein the tapered slot is tapered across the top face of the screw head, such that the tapered slot is narrowest at a center portion of the screw head and widens outwardly towards a circumferential edge.

17. The adapted screw head and screwdriver device of claim 16, wherein the screwdriver tip comprises a screw slot insertion end, a driven portion, and a middle portion that is positioned between the insertion end and the driven portion.

18. The adapted screw head and screwdriver device of claim 17, wherein the screw slot insertion end comprises a bottom face that, when in use, mates against the flat bottom surface.

19. The adapted screw head and screwdriver device of claim 16, wherein each of the screwdriver tip and the shaft are magnetic.

20. A method of inserting or removing a screw with a screwdriver without stripping comprising the steps of:
providing a screw and a screwdriver, wherein a screw head of the screw comprises a tapered opening that is sized and configured to accommodate the screwdriver in a snug fit;
inserting a tip of the screwdriver into the tapered opening of the screw head; and
applying torque to the screwdriver to drive the screw securely into an item.
